(19) United States
(12) Patent Application Publication
(10) Pub. No.: US 2009/0094172 A1
(43) Pub. Date: Apr. 9, 2009

(54) VOLUME RATING BY POSTAL METER

(75) Inventor: Thomas J. Foth, Trumbull, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Shelton, CT (US)

(21) Appl. No.: 11/869,157

(22) Filed: Oct. 9, 2007

(51) Int. Cl. G06F 9/00

(52) U.S. Cl. 705/408; 705/410

(57) ABSTRACT

A postage meter may be used to automatically apply volume rating to batches of mail pieces. In some embodiments, a batch of mail pieces is fed twice through the postage meter. In the first feeding the batch of mail is counted by the meter and on the second feeding meter indicia are applied to the mail pieces in accordance with a volume rating category established by the piece count provided by the first feeding. In other embodiments, the meter is set in advance to reflect a volume rating category, and the batch of mail is fed through the meter only once, to simultaneously meter the mail pieces and to count the batch for the purpose of verifying the volume rating category.

### FIELD OF THE INVENTION

The invention disclosed herein relates generally to mail processing and more particularly is concerned with operating a postage meter in relation to a batch of mail pieces.

### BACKGROUND

As is well known, postal authorities such as the U.S. Postal Service customarily provide discounted postage rates to mailings in which the mail pieces have been prepared so as to aid the postal authority in its handling of mail. For example, mailers who sort their mailings by destination postal code (and/or who apply a barcode that represents the postal code and/or who sort their mailings so that the individual mail pieces are arranged in the same order in which they are to be delivered by a mail carrier) may receive the benefit of discounted postage rates.

It may be contemplated that postage rate discounts may be granted based on the size of a batch of mail inducted into the postal authority for processing and delivery by the postal authority. This may be done to reflect efficiencies provided to the postal authority by supplying mail to the postal authority in relatively large batches. For example, a batch of mail numbering at least 10,000 pieces may receive a per piece discount of a few tenths of a cent relative to smaller but otherwise similar batches of mail. In addition or alternatively, a larger per piece discount may be provided to batches of mail that number at least 25,000 pieces. Thus volume-based postage rate categories may be established. Of course, different volume-based rate category boundaries and/or a larger or smaller number of categories may be established according to various volume rating schemes.

In some cases, the number of mail pieces in a batch of mail may be known in advance from data used to computer-generate the batch of mail. However, in other cases it may be difficult or impossible for a mailer to know, in advance of postage metering, what the piece count is for a batch of mail. In the latter cases, it may not be easy to readily determine whether and/or to what extent the batch of mail qualifies for a volume discount. Consequently, some mailers, in at least some circumstances, may have difficulty in availing themselves of volume discounts for batches of mail.

### SUMMARY

According to an aspect of the invention, a method includes feeding a batch of mail pieces through a postage meter while operating the postage meter to count the batch of mail pieces. By counting the batch of mail pieces, a piece count for the batch of mail pieces is determined. The method further includes feeding the batch of mail pieces again through the postage meter to apply postage indicia to the mail pieces.

The method may further include setting the postage meter after the first feeding step and before the second feeding step. The postage meter may be set to print a certain amount of postage on each mail piece and the amount of postage to be printed may be based at least in part on the piece count for the batch of mail pieces.

The method may further include storing the piece count for the batch of mail pieces in the postage meter. The postage meter may determine the certain amount of postage based at least in part on the stored piece count.

The postage meter may receive input from a user to indicate that the first feeding step is complete.

According to another aspect of the invention, a method includes entering, into a postage meter, data related to an estimated piece count for a batch of mail pieces. The method further includes setting the postage meter to print a certain amount of postage on each of the mail pieces. The certain amount of postage is based at least in part on the estimated piece count for the batch of mail pieces. The method also includes feeding the batch of mail pieces through the postage meter (a) to apply postage indicia to the mail pieces in accordance with the certain amount of postage, (b) and also to count the batch of mail pieces, thereby determining the actual piece count for the batch of mail pieces simultaneously with applying the postage indicia to the mail pieces.

In addition, the method includes determining whether the actual piece count verifies the entered data related to the estimated piece count.

The method according to this aspect may also include, if the actual piece count does not verify the data related to the estimated piece count, operating the postage meter to print a postage receipt to make up the shortfall in the postage applied to the batch of mail pieces by the postage meter. If the actual piece count verifies the data related to the estimated piece count, the postage meter may be operated to print a certificate to evidence the actual piece count.

The data that is entered related to the estimated piece count may directly indicate the estimated piece count or may be indicative of a piece-count-based postal rating category.

According to still another aspect of the invention, a postage meter includes a control circuit and a postage security mechanism, in communication with the control circuit, for storing postage funds. The postage meter further includes a printer, in communication with the control circuit, for printing postage indicia seriatim on a batch of mail pieces. The postage meter also includes a transport mechanism for transporting the mail pieces past the printer, and an input mechanism, in communication with the control circuit, for receiving data input from a user. In addition, the postage meter includes a display, in communication with the control circuit, for displaying information to the user.

The control circuit is operative to count the batch of mail pieces, while the batch of mail pieces is fed through the postage meter, to obtain a piece count for the batch of mail pieces. The control circuit is further operative to determine, based at least in part on the piece count, a certain amount of postage to be printed on the mail pieces. The control circuit is also operative to print the certain amount of postage on each of the mail pieces while the batch of mail pieces is fed again through the postage meter.

The control circuit may also be operative to receive input from a user to indicate completion of the first feeding operation of the batch of mail pieces through the postage meter.

According to still another aspect of the invention, a postage meter includes a control circuit and a postage security mechanism, in communication with the control circuit, for storing postage funds. The postage meter further includes a printer, in communication with the control circuit, for printing postage indicia seriatim on a batch of mail pieces. The postage meter also includes a transport mechanism for transporting the mail pieces past the printer, and an input mechanism, in communication with the control circuit, for receiving data input from a user. In addition, the postage meter includes a display, in communication with the control circuit, for displaying information to the user.

The control circuit is operative to receive input from a user to indicate an estimated piece count for a batch of mail pieces. The control circuit is further operative to count the batch of mail pieces, while the printer is printing the postage indicia on the mail pieces, in order to generate an actual piece count for the batch of mail pieces. The control circuit is also operative to compare the actual piece count with the estimated piece count.

The control circuit may be further operative, if the actual piece count does not match the estimated piece count, to print a postage receipt to make up a shortfall in postage applied to the batch of mail pieces. If the actual piece count does match the estimated piece count, the control circuit may be operative to print a certificate to evidence the actual piece count.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram that illustrates a postage meter that may be programmed and operated in accordance with aspects of the present invention.

FIG. 2 is a flow chart that illustrates a process that may be performed in accordance with aspects of the present invention with the postage meter of FIG. 1.

FIG. 3 is a flow chart that illustrates an alternative process that may be performed in accordance with aspects of the present invention with the postage meter of FIG. 1.

### DETAILED DESCRIPTION

In accordance with aspects of the present invention, a postage meter may be used to automatically count a batch of mail pieces. This may occur either prior to or simultaneously with the meter applying postage indicia to the mail pieces. In this way, a batch of mail pieces may be pre-qualified for volume rating, or the qualification of the batch of mail for volume rating may be confirmed. In the event that the postage meter counts the batch at the same time it applies postage indicia, and the batch of mail fails to satisfy the volume requirement, the postage meter may be used to pay the resulting shortfall in postage by issuing a suitable receipt to reflect deduction of the shortfall from postage funds stored in the meter.

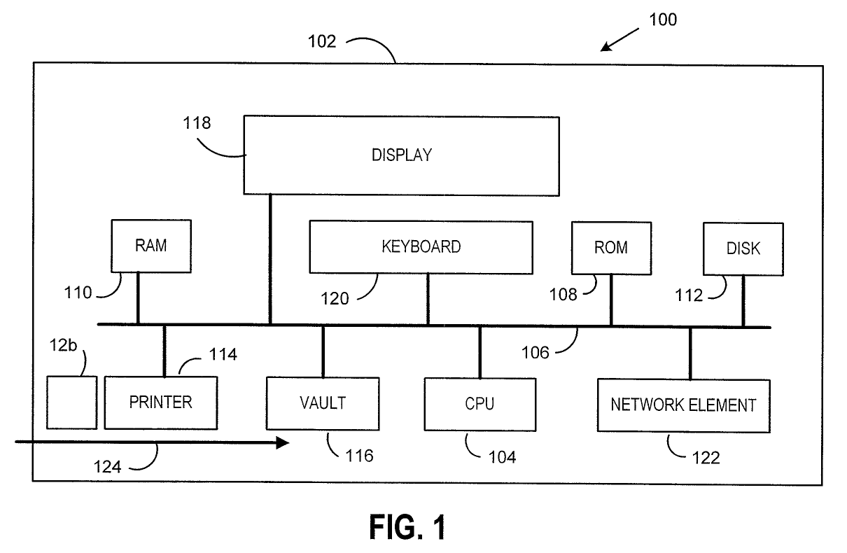

FIG. 1 is a block diagram that illustrates a postage meter 100 that may be programmed and operated in accordance with aspects of the present invention.

Postage meter 100 may include a housing 102 that supports and/or contains other components (enumerated below) of the postage meter 100. The postage meter 100 may also include a processor 104 (e.g., a conventional microprocessor or microcontroller) that controls over-all operation of the postage meter 100, and thus functions as a control circuit for the postage meter 100. Further, the postage meter 100 may include a data bus 106 to which the processor 104 is coupled.

In addition, the postage meter 100 may include a ROM (read only memory) 108 coupled to the data bus 106 and RAM (random access memory) 110 coupled to the data bus 106. ROM 108 may provide program memory (for boot code, e.g.). RAM 110 may serve, for example, as working memory and/or temporary program memory.

Still further, the postage meter 100 may include a hard disk drive 112 that is also coupled to the data bus 106. The hard disk drive 112 may, for example, serve as mass storage and/or permanent/semi-permanent storage for one or more applications or other programs that may be temporarily loaded into RAM 108 to control the processor 104.

Also, the postage meter 100 may include a printer 114 that prints postage indicia on mail pieces (not shown) and a “vault” component 116 that securely stores and disburses postage to support the printing of the postage indicia. Both the printer 114 and the vault 116 may also be coupled to the data bus 106. The vault 116 may also be referred to as a postage security device or postage security mechanism.

Moreover, the postage meter 100 may include a user interface that comprises, for example, a display (e.g., a liquid crystal display) 118 and a keyboard 120, both also coupled to the data bus 106. As is customary in devices such as the postage meter 100, the keyboard 120 may function as an input mechanism by which the postage meter 100, and particularly the processor 104, may receive data input from a user of the postage meter 100.

Furthermore, the postage meter 100 may include a network element 122 (e.g. a modem or an Ethernet controller) that is coupled to the data bus 106 and enables the postage meter 100 to engage in data communications with external devices (such as a postage-meter-recharging system, which is not shown).

A transport or feed mechanism, schematically represented by arrow 124, operates to transport mail pieces one by one past the printer 114 to allow the printer 114 to print the postage indicia on the mail pieces. Strictly speaking, the transport mechanism may be considered part of a mailing machine (not separately shown) in which the postage meter 100 is installed, but for present purposes the transport mechanism 124 may be deemed a part of the postage meter 104. Control functions for the transport mechanism 124 may be provided by a suitable (and conventional) controller, which is not shown, but may be in communication with the processor 104. Alternatively, the control function for the transport mechanism 124 may be integrated with the processor 104.

The postage meter 100 (and/or the mailing machine of which it is a part) may further include one or more sensors (such as sensor 126). The sensor(s) may be in communication with the processor 104, either directly or indirectly, and may operate to detect the arrival of each mail piece at the printer 114. The sensor(s) may trigger both printing of a postage indicium by the printer 114 on the current mail piece, and also may trigger an increment of the batch piece count which is described below.

The postage meter 100 may, in some embodiments, be entirely conventional in terms of its hardware aspects, but may be suitably programmed in accordance with aspects of the invention to function as described herein.

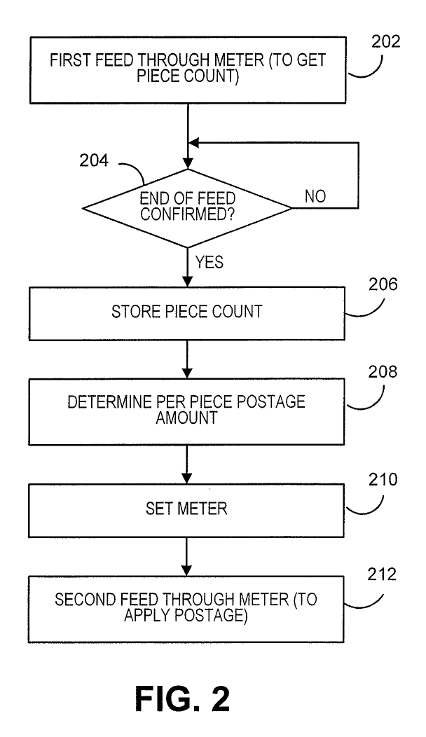

FIG. 2 is a flow chart that illustrates a process that may be performed in accordance with aspects of the present invention with the postage meter 100. The process of FIG. 2 is concerned with the postage meter processing a batch of mail pieces (not shown).

Initially in the process as depicted in FIG. 2, at 202, the user causes the batch of mail pieces to be fed through the postage meter 100. This may be done, for example, after the user puts the postage meter 100 in a “count batch” mode of operations. The purpose of this feeding of the batch of mail through the postage meter 100 is to allow the postage meter to count the batch of mail pieces to produce a piece count for the batch of mail pieces. For example, each time the sensor 126 detects feeding of a new mail piece by the transport mechanism 124, the sensor may send a suitable signal to the processor 104, and the processor 104, in turn, may increment the piece count for the batch of mail pieces. If feeding of mail pieces ceases, the postage meter may prompt the user (via display 118) to confirm (decision block 204, FIG. 2) that feeding of the batch of mail pieces is complete, and the user may so indicate, by suitable input via the keyboard 120. The processor 104 may then store (e.g., in RAM 110) the piece count for the batch of mail pieces (block 206, FIG. 2).

Based on the piece count, and also possibly on the basis of suitable programming and/or a suitable database and/or rate table, the processor 104 may determine (block 208, FIG. 2) whether or not the batch of mail pieces qualifies for a volume discount in the postage to be applied to the mail pieces. As a result of this determination (and possibly based also on rate data, class data, sortation characteristic data or other data entered by the user), the postage meter may set itself (block 210, FIG. 2) to print postage indicia in a denomination (amount) which corresponds to the volume-based postage rate to which the batch of mail is entitled.

Next, as indicated by block 212, the user again feeds the batch of mail pieces through the postage meter. The purpose of this feeding of the batch of mail through the postage meter is to allow the postage meter to apply postage indicia to the mail pieces in the denomination set at 210. The result is that the batch of mail is metered with postage in an amount which reflects any volume discount for which the batch of mail qualifies. Moreover, the postage meter itself, having counted the batch at the first feeding (block 202), can automatically and reliably set itself to properly apply the volume discount when the batch of mail is entitled to the discount.

In an alternative embodiment, the postage meter, after first counting the batch of mail, may display to the user one or more of (a) the piece count for the batch of mail, (b) the volume rating category into which the batch of mail falls, and (c) the appropriate amount of postage to be applied to each of the mail pieces. The user may then, on the basis of the displayed information, set the postage meter to print the appropriate postage denomination.

In other embodiments, the mail pieces within a single batch may fall into different weight categories for rating purposes (e.g., some pieces one ounce or less, others more than one ounce). In such embodiments, the postage meter may be interfaced to a postal scale (not shown), such as a “weigh on the way” scale. The postal scale may provide weight data for each mail piece to the postage meter, which may then automatically determine the appropriate amount of postage for each mail piece based on the mail piece's weight, and also based on the volume rating category applicable to the batch of mail. It will be recognized that other factors besides weight and volume rating category may also be taken into consideration in arriving at the correct postage amount for each mail piece.

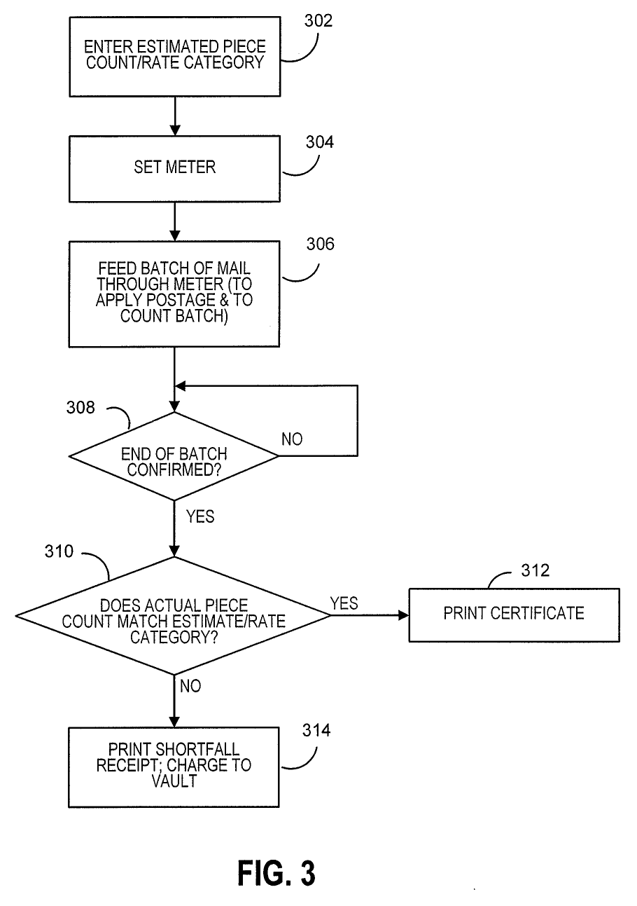

FIG. 3 is a flow chart that illustrates an alternative process that may be performed in accordance with aspects of the present invention with the postage meter 100. Like FIG. 2, FIG. 3 is concerned with the postage meter 100 processing a batch of mail, which is not shown.

At 302 in FIG. 3, the user enters into the postage meter 100, via the keyboard 120, data that indicates, directly or indirectly, the user's estimate of the piece count for a batch of mail pieces to be metered. For example, the user may simply enter a number of mail pieces believed to be present in the batch of mail pieces. Alternatively, the user may be prompted to select one of a plurality of piece count categories displayed on the display 118 (e.g., “Less than 10,000”, “10,001-25,000”, “More than 25,000”). By selecting the piece count category that the user believes the batch falls into, the user enters data to indirectly indicate the estimated piece count for the batch. It will be appreciated that these piece count categories may correspond to volume rating categories established by the postal authority.

As still another alternative, the user may be prompted to select a volume rating category by a name such as “no volume discount”, “intermediate level volume discount”, “maximum volume discount”. By selecting one of these volume rating categories, the user may effectively be entering an estimate that the batch piece count falls within the piece count category that corresponds to the selected volume rating category.

Based at least in part on the piece count data, or the piece count category or volume rating category selected by the user, the postage meter may set itself (block 304, FIG. 3) to print postage indicia in a denomination which corresponds to the appropriate rate to which the batch of mail is entitled, assuming that the user's estimate of the piece count is correct.

Next, as indicated at 306, the user feeds the batch of mail pieces through the postage meter 100. The purpose of this feeding of the batch of mail pieces through the postage meter is to both apply postage indicia to the mail pieces and to allow the postage meter to count the mail pieces to verify the user's estimate of the piece count. Accordingly, the processor 104 causes the printer 114 to print a postage indicium on each mail piece, while also counting the mail pieces to determine an actual piece count for the batch of mail pieces. (In an alternative embodiment, each mail piece may also be weighed, and the indicium denomination may be set based in part on the weight category into which each mail piece falls.)

If feeding of the mail pieces ceases, the postage meter may prompt the user (via display 118) to confirm (decision block 308, FIG. 3) that feeding of the batch of mailing pieces is complete, and the user may so indicate, by suitable input via the keyboard 120. The processor then finalizes the piece count for the batch of mail pieces and determines (decision block 310) whether the final, actual piece count for the batch matches the estimated piece count indicated, directly or indirectly, by the user input. The actual piece count may be considered to “match” the estimated piece count if the actual piece count qualifies the batch of mail to the same volume rating category as the indicated estimated piece count.

If the actual piece count for the batch of mail pieces was found at 310 to match the estimated piece count, then the process of FIG. 3 may advance from decision block 310 to block 312. At block 312, the postage meter 100 may print a suitable certificate to indicate that the estimated piece count, upon which volume rating was applied in the metering of the batch of mail pieces, was verified by the postage meter. (For example, the postage meter may prompt the user to feed a suitable blank piece of paper through the meter, to allow the meter to print the certificate on the blank piece of paper.)

If the actual piece count for the batch of mail pieces was found at 310 not to match the estimated piece count, then the process of FIG. 3 may advance from decision block 310 to block 314. At block 314, the postage meter 100 may conclude that the postage indicia printed on the mail pieces were in an inappropriately low denomination, since the batch of mail pieces failed to qualify for the volume discount reflected by the postage indicia. The postage meter may then calculate the resulting shortfall in total postage dispensed for the batch of mail pieces, and may deduct the resulting shortfall from the postage funds stored in the vault 116 (FIG. 1). As part of the same process, the postage meter may print a suitable receipt to provide evidence that the shortfall was paid. (For example, the postage meter may prompt the user to feed through the meter a suitable label blank or the like, upon which the receipt may be printed.) Thereafter, the user may submit the receipt to the postal authority at the time the batch of mail is delivered to the postal authority. In this way, the user may be excused from paying for the shortfall a second time, and the postal authority may accept the mail pieces for processing and delivery, notwithstanding that insufficient postage was initially applied to the mail pieces.

With the process illustrated in FIG. 3, a postage meter may be utilized to apply, and automatically verify, volume rating for batches of mail pieces, without requiring the batches of mail pieces to be fed twice through the postage meter.

In some embodiments, it may be desirable to set the postage meter so as to print postage at a rate that corresponds to the highest volume-based discount in the applicable rate structure, since if the user underestimates the batch piece count in setting the meter, the meter may print a higher than required postage amount on each mail piece, and it may be difficult for the user to obtain a refund of the excess postage.

In some embodiments, the postage meter 100 may operate to allow the user to selectively place the meter in a first mode, in which the meter operates in accordance with the process of FIG. 2 (volume rating with the batch of mail twice fed through the meter), or in a second mode, in which the meter operates in accordance with the process of FIG. 3 (volume rating with the batch of mail fed only once). From one point of view, the first mode may be referred to as a “self-setting volume rating mode”, whereas the second mode may be referred to as a “user-set volume rating mode”. The postage meter, in at least some of such embodiments, may also be selectively operable in other modes, possibly including other volume rating modes.

The method steps described herein in connection with either or both of FIGS. 2 and 3 need not be performed in the order set forth above. Rather, the steps may be performed in any order that is practicable.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
feeding a batch of mail pieces through a postage meter while operating the postage meter to count the batch of mail pieces, thereby determining a piece count for the batch of mail pieces; and
after said feeding step, feeding the batch of mail pieces through the postage meter a second time to apply postage indicia to the mail pieces.

2. The method of claim 1, further comprising:
after the first feeding step and before the second feeding step, setting the postage meter to print a certain amount of postage on each mail piece, the certain amount of postage based at least in part on the piece count for the batch of mail pieces.

3. The method of claim 2, further comprising:
storing the piece count for the batch of mail pieces in the postage meter.

4. The method of claim 3, further comprising:
the postage meter determining said certain amount of postage based at least in part on the stored piece count.

5. The method of claim 4, further comprising:
the postage meter receiving input from a user to indicate that the first feeding step is complete.

6. A method comprising:
entering, into a postage meter, data related to an estimated piece count for a batch of mail pieces;
setting the postage meter to print a certain amount of postage on each of the mail pieces, the certain amount of postage based at least in part on the estimated piece count for the batch of mail pieces;
feeding the batch of mail pieces through the postage meter
(a) to apply postage indicia to the mail pieces in accordance with the certain amount of postage;
(b) and also to count the batch of mail pieces, thereby determining an actual piece count for the batch of mail pieces simultaneously with applying the postage indicia to the mail pieces; and
determining whether the actual piece count verifies the entered data related to the estimated piece count.

7. The method of claim 6, further comprising:
if the actual piece count does not verify the data related to the estimated piece count, operating the postage meter to print a postage receipt to make up a shortfall in postage applied to the batch of mail pieces by the postage meter.

8. The method of claim 6, further comprising:
if the actual piece count verifies the data related to the estimated piece count, operating the postage meter to print a certificate to evidence the actual piece count.

9. The method of claim 6, wherein the entered data related to the estimated piece count directly indicates the estimated piece count.

10. The method of claim 6, wherein the entered data related to the estimated piece count is indicative of a piece-count-based postal rating category.

11. A postage meter, comprising:
a control circuit;
postage security means, in communication with the control circuit, for storing postage funds;
a printer, in communication with the postage security means, for printing postage indicia seriatim on a batch of mail pieces;
transport means for transporting the mail pieces past the printer;
input means, in communication with the control circuit, for receiving data input from a user; and
a display, in communication with the control circuit, for displaying information to the user;
wherein the control circuit is operative to:
count a batch of mail pieces while the batch of mail pieces is fed through the postage meter, to obtain a piece count for the batch of mail pieces;
determine, based at least in part on the piece count, a certain amount of postage to be printed on the mail pieces; and
print the certain amount of postage on each of the mail pieces while the batch of mail pieces is fed again through the postage meter.

12. The postage meter of claim 11, wherein the control circuit is further operative to:
receive input from a user to indicate completion of feeding of the batch of mail pieces through the postage meter to obtain the piece count.

13. A postage meter, comprising:
a control circuit;
postage security means, in communication with the control circuit, for storing postage funds;
a printer, in communication with the postage security means, for printing postage indicia seriatim on a batch of mail pieces;
transport means for transporting the mail pieces past the printer;
input means, in communication with the control circuit, for receiving data input from a user; and
a display, in communication with the control circuit, for displaying information to the user;
wherein the control circuit is operative to:
receive input from a user to indicate an estimated piece count for a batch of mail pieces;
count the batch of mail pieces, while the printer is printing the postage indicia thereon, in order to generate an actual piece count for the batch of mail pieces; and
compare the actual piece count with the estimated piece count.

14. The postage meter of claim 13, wherein the control circuit is further operative to:
if the actual piece count does not match the estimated piece count, print a postage receipt to make up a shortfall in postage applied to the batch of mail pieces.

15. The postage meter of claim 13, wherein the control circuit is further operative to:
if the actual piece count matches the estimated piece count, print a certificate to evidence the actual piece count.
